(19) United States
(12) Patent Application Publication
(10) Pub. No.: US 2002/0188703 A1
(43) Pub. Date: Dec. 12, 2002

(54) Graphical tool for developing computer programs via specifications

(75) Inventor: John Alden, Edina, MN (US)

Correspondence Address: SCHWEGMAN, LUNDBERG, WOESSNER & KLUTH, P.A., P.O. BOX 2938, MINNEAPOLIS, MN, 55402, US

(73) Assignee: McKesson Information Solutions Holdings Ltd.

(21) Appl. No.: 10/163,011

(22) Filed: Jun. 4, 2002

Related U.S. Application Data
(60) Provisional application No. 60/295,653, filed on Jun. 4, 2001.

(51) Int. Cl. G06F 15/177; G06F 15/16

(52) U.S. Cl. 709/220; 709/203

(57) ABSTRACT

A method, system, apparatus, and program product for developing a specification, which may be a form of program expression independent of a client device. A host at the client converts the specification elements into a running application at the client that is specific to the client platform. The application may run concurrently with the modification of the specification, which allows for user customization of the application while the application is running.

### CROSS REFERENCE TO RELATED APPLICATIONS

This application claims priority to provisional application serial No. 60/295,653, filed Jun. 4, 2001, which is hereby incorporated herein by reference.

### FIELD OF THE INVENTION

This invention relates generally to information processing and more particularly to developing computer programs via a specification.

### BACKGROUND OF THE INVENTION

Client/Server application development has undergone tremendous change as real-world deployment issues have surfaced. The movement from mainframe/terminal based solutions to a personal computer based client and a server has brought powerful capabilities to the user's desktop along with some unexpected complexities and costs.

Applications have tended to be either mainframe-based with dumb terminals, or small local server-based systems. The both have their problems. The mainframe-based systems were good for many years, however, the computing paradigm has migrated toward a client/server environment. This leaves less and less incentive to update and modify the mainframe-based systems. Further, the use of a dumb terminal required an investment in equipment that could only be used for applications that were run on the mainframe. Their capabilities were so limited that they essentially only echoed keystrokes back to a mainframe computer, which then generated the display to be provided and sent it back to the terminal via a network connection. They became limited to crude, menu-based systems with extremely limited graphics capabilities, if any.

Applications developed using the client/server approach place ever increasing demands on the client hardware and software. Usually, as the application program is enhanced, more and more functionality is required of the client, which becomes known as a thick client. This can result in faster hardware obsolescence, as the client responds more and more slowly as it needs to process more information. The enhancements and code fixes create administrative problems in ensuring that each client has the latest version of the code. Further, as users customize their machines with more and more software, conflicts and incompatibilities are likely to result, requiring the services of computer maintenance personnel to fix each client. The fact that each client may be differently configured further adds to the confusion. In addition, complicated presentations, while possible, are difficult to code and must be coded for a specific client platform, e.g. a Unix platform requires different code from a Microsoft Windows platform. Further, code is difficult to customize and difficult to tailor to a particular user. As a result, complex GUIs (Graphical User Interface) at the thick client are more expensive to create and maintain and require specialized programmers whose skills are in short supply.

In an attempt to address the problems of a thick client, developers have tried using a thin client that interacts with the server using a browser. Browser-based presentations have complementary advantages and disadvantages. For example, HTML (Hypertext Markup Language) is easy to learn, and very complex user interfaces can be created quickly by relatively inexperienced programmers. Since all HTML is generated on the server and sent to the client, there is no problem keeping the client code updated. On the other hand, virtually every event that results in a change in the appearance of the user interface requires a server interaction and incurs its resulting latency. Users become frustrated when three to five second delays occur frequently, and intensive data entry applications are often economically unviable in this mode. In addition, HTML is not currently extensible, and the only GUI elements that exist are defined by a relatively small set of tags. Also, creating sophisticated graphical elements that are not already supported in HTML is beyond the skills of most programmers. Finally, generating web pages that are stored on servers does not provide for data binding.

Thus, there is a need in the industry for a program development tool that is easy to program, easy to use, easy to maintain, and provides good performance and easy customization by users and non-programmers.

### SUMMARY OF THE INVENTION

The present invention provides solutions to the above-described shortcomings in conventional approaches, as well as other advantages apparent from the description below.

The present invention provides a method, apparatus, system, and signal-bearing medium for developing application software, which in an embodiment may be a GUI (graphical user interface) based application. A specification may be created at any client device, where the specification may be a form of program expression independent of the client device. At program execution time, a host framework at the client converts the specification elements into a running application at the client that is specific to the client platform. The application may run simultaneously with the specification being revised. In this way, the user can simultaneously revise the specification and run the application, and thus customize the application as it is used.

### BRIEF DESCRIPTION OF THE DRAWINGS

FIG. 1 depicts a pictorial example of a network of computer systems that can be used to implement an embodiment of the invention.

FIGS. 2A and 2B depict block diagrams of the principal components of a client and server attached via a network in an embodiment of the invention.

FIG. 3 depicts a pictorial representation of an example user interface for creating a new screen, according to an embodiment of the invention.

FIG. 4 depicts a pictorial representation of an example user interface for creating a screen object, according to an embodiment of the invention.

FIG. 5 depicts a pictorial representation of an example user interface for creating an input specification, according to an embodiment of the invention.

FIG. 6 depicts a pictorial representation of an example user interface for creating a style sub-specification, according to an embodiment of the invention.

FIG. 7 depicts a pictorial representation of an example user interface for creating a modal dialog specification, according to an embodiment of the invention.

FIG. 8 depicts a pictorial representation of an example user interface that shows the result of the specification of the dialog's title.

FIG. 9 depicts an example business object that is used to run an embodiment of the invention.

FIG. 10 depicts an example document, according to an embodiment of the invention.

FIG. 11 illustrates a flowchart that describes a method for carrying out a design-time embodiment of the invention.

FIG. 12 illustrates a flowchart that describes a method for carrying out a runtime embodiment of the invention.

FIG. 13 illustrates a pictorial representation of an example user interface for modifying a specification simultaneously with running an application, according to an embodiment of the invention.

### DETAILED DESCRIPTION OF THE INVENTION

In the following detailed description of exemplary embodiments of the invention, reference is made to the accompanying drawings (where like numbers represent like elements) that form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

Overview

An embodiment of the present invention provides a tool for developing application software. The tool may operate at a client to produce a specification, which is a form of program expression independent of the client device. A host at the client converts, or instantiates, the specification elements into a running application at the client in a form specific to the client platform.

In an embodiment, the specification may be encoded in XML (Extensible Markup Language), a common format for data exchange that is also accepted by browsers. But, in other embodiments any appropriate format may be used. In an embodiment, the specification may specify an application using the Model-View-Controller architecture, but in other embodiments any appropriate application architecture may be used.

In an embodiment, the specification may be a screen specification and may specify a GUI (graphical user interface) based application. Although the examples shown in the below-described figures are directed toward this GUI-based application embodiment, in other embodiments, the specification may specify any appropriate type of application. In an embodiment, the screen specification is an XML (Extensible Markup Language) document, although in other embodiments, any screen-specification language can be used. The screen specification may include a complete specification of the screen's appearance, as well as an identification of the location of the origin of the data for the screen. In an embodiment, the specification is condensed and will be transformed into executable code at the client. In an embodiment, the specification is expanded at the client into HTML, although in other embodiments, any appropriate definition language can be used.

A controller document is provided that defines the flow from screen to screen in an application, as well as the calls required to access the services needed by the application. In an embodiment, the calls are SOAP (Simple Object Access Protocol) calls to web services, although in other embodiments other appropriate protocol can be used. These services include data access, data updating, and security, although other services can also be present. In an embodiment, the controller document is an XML document, although in other embodiments, any appropriate type of document can be used. The controller documents are interpreted or transformed into executable code by a framework at the client, and when interpreted or executed cause the correct screens to be invoked in sequence and provide the screens with the needed data. In an embodiment, the framework may implemented in Javascript. In another embodiment, the framework may be implemented via Microsoft.net. But, in other embodiments any appropriate document interpreter may be used.

All screen specifications and controllers required to run a complete application may be packed together into a single document, which in an embodiment is an XML document, which is downloaded to the client's browser via a standard URL. The browser will cache the document, so that subsequent uses of the application can be resolved locally. The host framework is automatically loaded as needed and cached by the browser. In an embodiment, calls to the server are SOAP transactions (XML over HTTP). Thus, the client can interact with end users at fast speeds with no code update or distribution problem. In addition, since HTML is generated at the client, complex graphical elements using JavaScript and Dynamic HTML can be built, which allows programmers who are not experts in these technologies to create complex user interfaces.

At program creation time, a GUI builder may construct screen specifications and controllers using input from a user provided via a drag and drop user interface. The GUI builder provides immediate feedback to the user on the appearance and behavior of the screens and controllers.

Detailed Technical Description

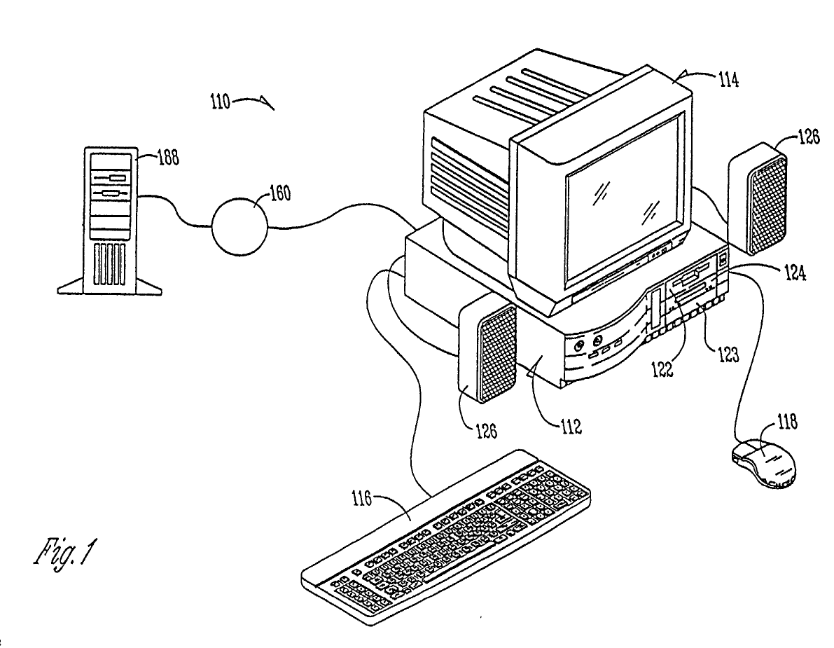

FIG. 1 depicts an example of a network of computer systems that can be used to implement an embodiment of the invention. Client computer system 110 is connected to remote server computer system 188 via network 160. Computer system 110 includes processing unit 112, display device 114, keyboard 116, pointing device 118, and speakers 126. Processing unit 112 receives input data from input devices such as keyboard 116, pointing device 118, and network 160 and presents output data to a user via display device 114 and speakers 126. Pointing device 118 is used in conjunction with a graphical user interface (GUI) in which hardware components and software objects are controlled through the selection and the manipulation of associated graphical objects displayed within display device 114. Although computer system 110 is illustrated with a mouse for pointing device 118, in other embodiments any type of graphical-pointing device such as a graphic tablet, joystick, trackball, or track pad can also be used.

Keyboard 116 is that part of computer system 110 that resembles a typewriter keyboard and that enables a user to control particular aspects of the computer.

Video-display terminal 114 is the visual output of computer system 110. Video-display terminal 114 can be a cathode-ray tube (CRT) based video display well known in the art of computer hardware. But, with a portable or notebook-based computer, video display terminal 114 can be replaced with a liquid crystal display (LCD) based or gas, plasma-based, flat-panel display. In other embodiments, video-display terminal 114 is any type of device capable of displaying information.

To support storage and retrieval of data, processing unit 112 further includes diskette drive 122, hard-disk drive 123, and tape drive 124, which are interconnected with other components of processing unit 112. Although diskette drive 122, hard-disk drive 123, and tape drive 124 are shown incorporated into system unit 112, they could be external to system unit 112, either connected directly, on a local area network (LAN), on network 160, or attached to remote computer system 188.

Computer system 110 can be implemented using any suitable computer such as a personal computer available form a number of vendors. In an embodiment, computer system 110 may be a configuration that includes all functional components of a computer and its associated hardware. In general, a typical computer system includes a console or processing unit such a processing unit 112, with one or more disk drives, a monitor such as video display terminal 114, and a keyboard such as keyboard 116. Remote computer system 188 can be implemented using any suitable computer that contains non-volatile storage. But, an embodiment of the present invention can apply to any hardware configuration that allows designing a specification regardless of whether the hardware configuration is a complete, multi-user computer apparatus, a single-user workstation, or a network appliance that does not have non-volatile storage of its own.

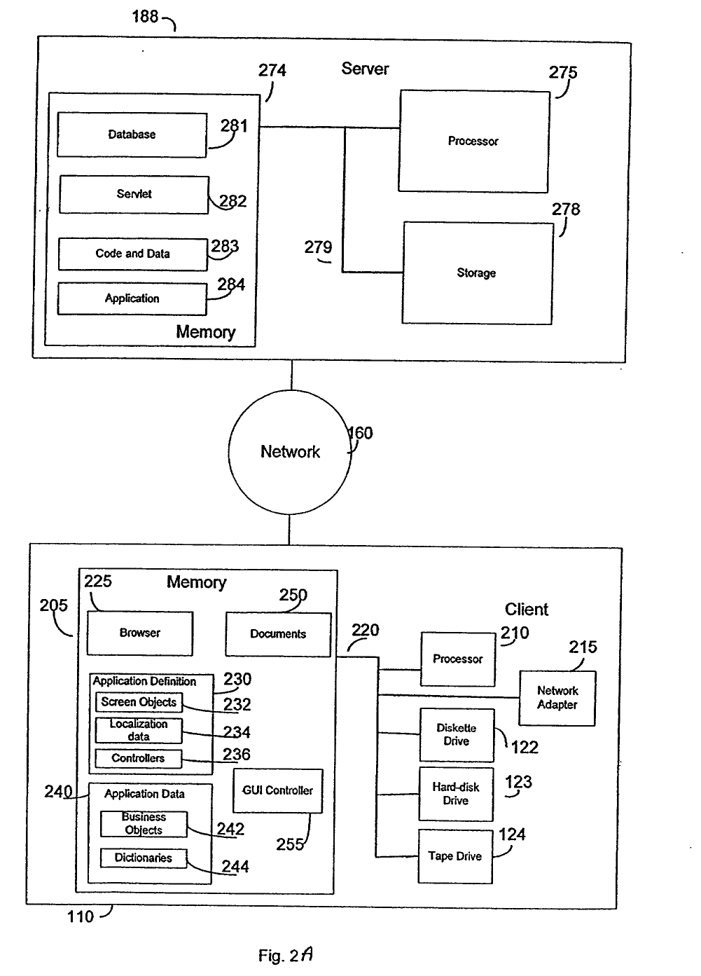

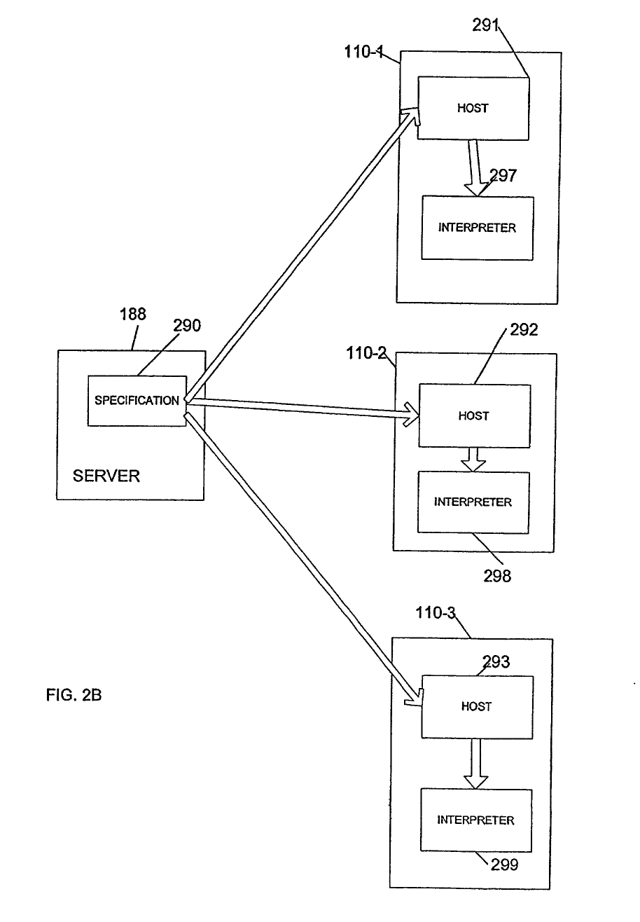

FIG. 2A depicts a block diagram of the principal components of client 110 and server 188 attached via network 160. Client 110 contains memory 205 connected via bus 220 to processor 210, diskette drive 122, hard-disk drive 123, tape drive 124, and network adapter 215. Although the various components of FIG. 2A are drawn as single entities, each may consist of multiple entities and may exist at multiple levels.

Memory 205 comprises an number of individual, volatile-memory modules that store segments of operating system and application software while power is supplied to client 110. The software segments are partitioned into one or more virtual memory pages that each contain an uniform number of virtual memory addresses. When the execution of software requires more pages of virtual memory than can be stored within memory 205, pages that are not currently needed are swapped with the required pages, which are stored within non-volatile storage, such as devices 122 or 123. Memory 205 is a type of memory designed such that the location of data stored in it is independent of the content. Also, any location in memory 205 can be accessed directly without needing to start from the beginning.

Memory 205 contains browser 225, application definition 230, application data 240, documents 250, and GUI controller 255. Browser 225 and GUI controller 255 contain instructions capable of being executed by processor 210. In another embodiment, browser 225 and GUI controller 255 can be implemented by control circuitry though the use of logic gates, programmable logic devices, or other hardware components in lieu of a processor-based system.

Browser 225 can be implemented via any browser that interprets control tags and data to display screens. Examples of browsers are Microsoft Internet Explorer and Netscape Navigator, although in other embodiments any suitable browser can be used.

Application definition 230 contains screen objects 232, optional localization data 234, and controllers 236.

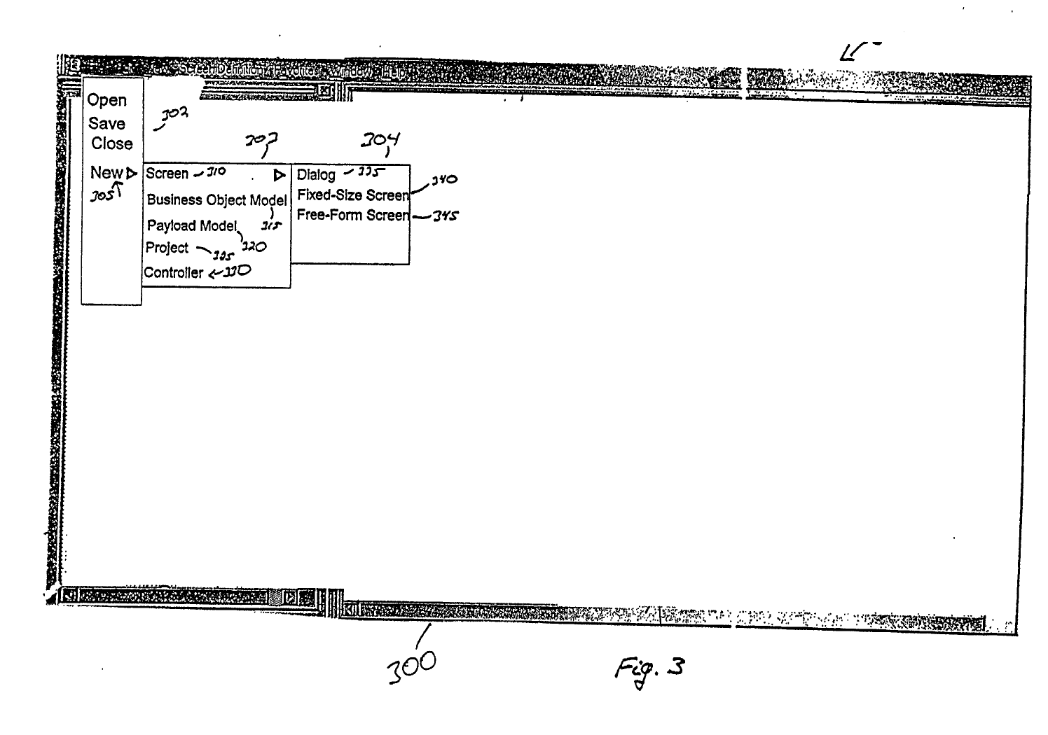

Screen objects 232 define the format and data of the user interface that is displayed on display screen 114. Examples of the display of screen object data are shown in FIGS. 3-8.

Optional localization data 234 customizes the screen objects for the local user. In an embodiment, localization data 234 customizes the application for the language spoken by the user.

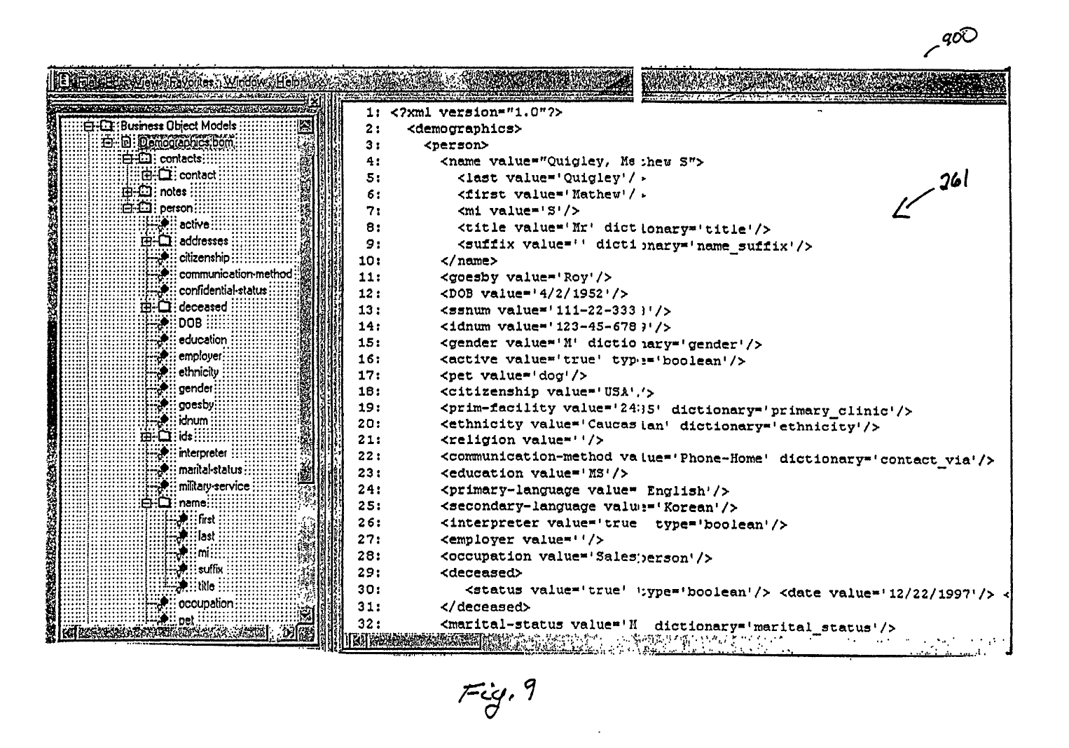

Application data 240 contains business objects 242 and dictionaries 244. Example contents of application data 240 are further described below with reference to FIG. 9.

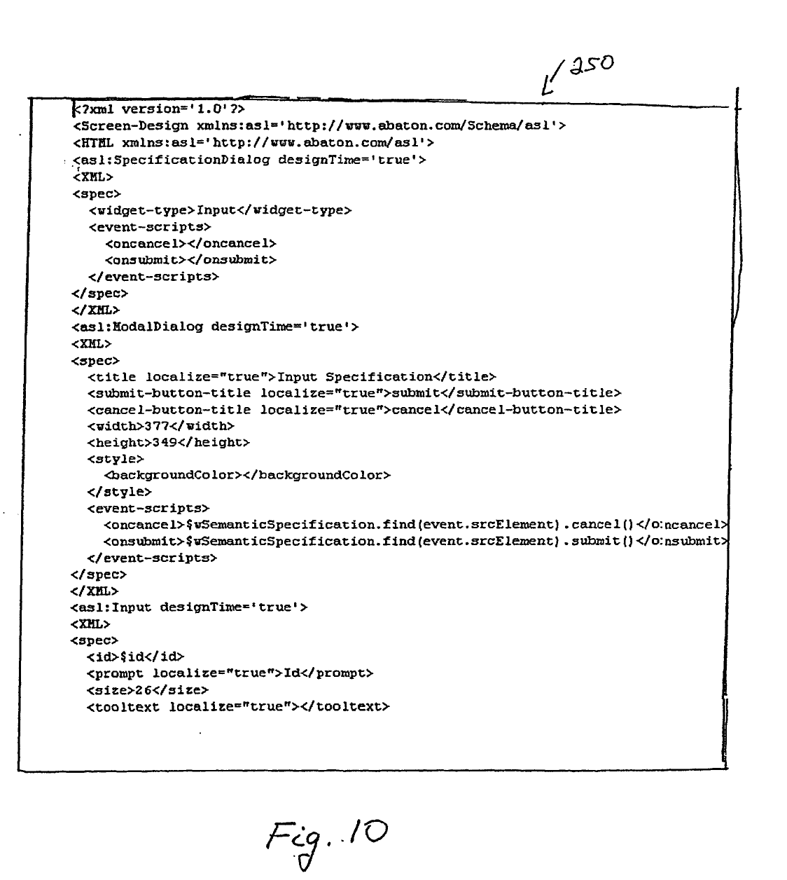

Documents 250 contain control tags and data that are created by GUI controller 255. In an embodiment, documents 250 contain control tags and data that conform to the DOM (Document Object Model) protocol, although in other embodiments any suitable protocol can be used. In another embodiment, documents 250 contain style sheets. One protocol for implementing style sheets is XSL (Extensible Style Language), although any suitable protocol can be used. Example contents of documents 250 are shown in FIG. 10.

In an embodiment, GUI controller 255 sends requests to and receives responses from server 188. In another embodiment, GUI controller 255 sends requests to and receives responses from an unillustrated process within client 110.

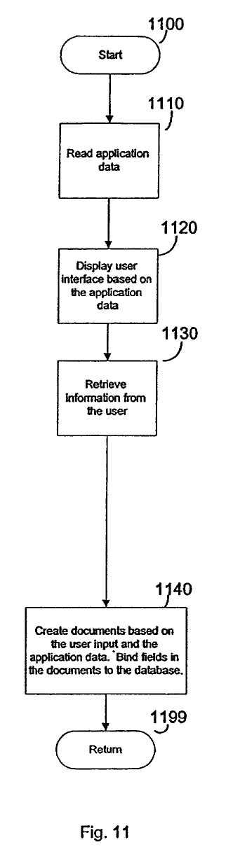

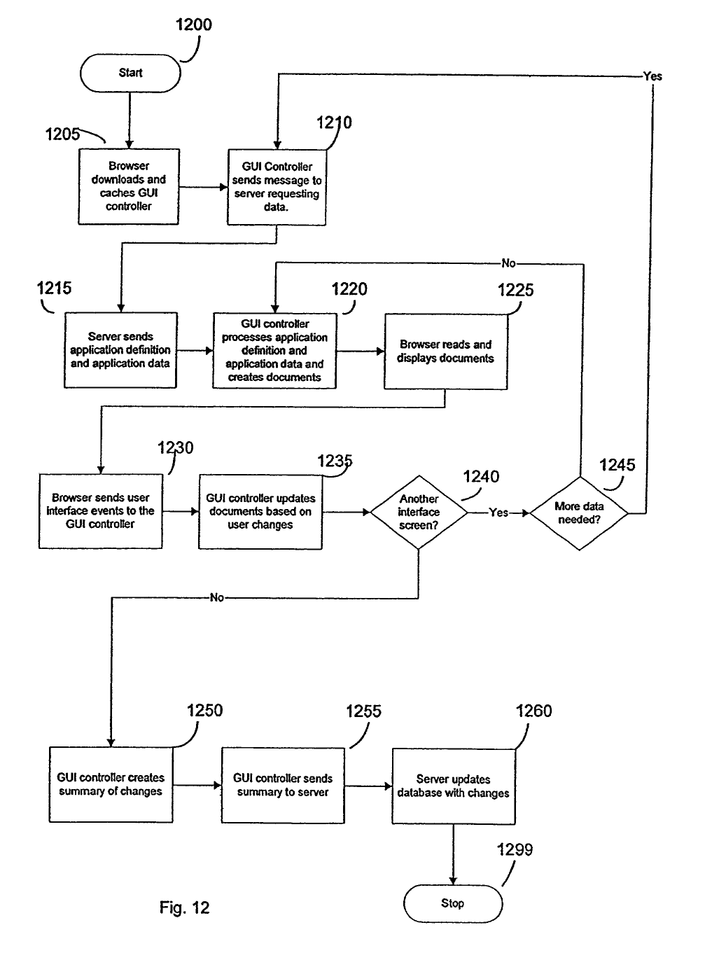

In an embodiment, GUI controller 255 receives application data 240 from network 160 and interprets the data within application data 240, in order to create documents 250 that browser 225 displays as the user interface on display 114 as shown in FIGS. 3-10, and to perform the actions shown in FIGS. 11 and 12. In another embodiment, application data 240 pre-exists at client 110, and it is not necessary to download it from a server. The operation of browser 225 and GUI controller 255 are further described below under the descriptions of FIGS. 3-12.

Processor 210 executes instructions and includes that portion of client 110 that controls the operation of the entire computer system, including executing the arithmetical and logical functions contained in a particular computer program. Although not depicted in FIG. 2A, processor 210 typically includes a control unit that organizes data and program storage in a computer memory and transfers data and other information between the various part of the computer system. Processor 210 accesses/stores data and instructions from/to memory 205.

Any appropriate processor could be utilized for processor 210. Although client 110 is shown to contain only a single processor and a single system bus, the present invention applies equally to computer systems have multiple processors and to computer system that have multiple buses that each perform different functions in different ways.

Diskette drive 122 and hard disk drive 123 are electromechanical devices that read from and write to magnetic disks, although any non-volatile storage devices could be used, such as CD-ROM drives. A disk is typically a round, flat piece of flexible plastic (e.g. floppy disk) or inflexible metal (e.g., hard disk) coated with a magnetic material that can be electrically influenced to hold information recorded in digital form. A disk is, in most computers, the primary method for storing data on a permanent or semi-permanent basis.

Tape drive 124 is an electromechanical device that reads from and writes to tape media. The tape media is typically a long, flat piece of flexible plastic influenced to hold information recorded in digital form. The flexible plastic can be wound on multiple, separate reels or within a cartridge.

Finally, client 110 includes network adapter 215, which facilitates communication between client 110 and network 160, which might be a local area network (LAN), a wide area network (WAN) an intranet, or the Internet, although in other embodiments any suitable type of network can be used. Network 160 provides a user of client 110 with a means of electronically communicating information, including software, with a remote computer or a network logical-storage device. In other embodiments, network 160 supports distributed processing, which enables client 110 to share a task with other computer systems linked to the network.

Network adapter 215 could also be a modem, which supports communication between client 110 and another computer system over a standard telephone line. Furthermore, through a modem, client 110 can access other sources such as server, an electronic bulletin board, and the Internet or World Wide Web.

Network 160 may include a plurality of networks, each of which could include a plurality of individual computers. Network 160 and server 188 can be located a great geographic distance from client 110, or in other embodiments they are in the same room or even on the same desktop. Client 110 can be connected to network 160 via a standard telephone line, a dedicated cable, a wireless communications link, or via any other suitable communications medium.

Server 188 contains memory 274, processor 275, and storage 278, which are all connected via system bus 279. Server 188 is capable of communicating across network 160 using a TCP/IP (Transmission Control Protocol/Internet Protocol) connection, although in other embodiments any suitable communications protocol can be used.

Memory 274 can be any type of computer memory, analogous to those described for memory 205. Memory 274 contains database 281, servlet 282, code and data 283, and application 284. Code and data 283 is uploaded and downloaded from client 110, as further described below with reference to FIGS. 11 and 12. Database 281 contains data of interest organized into fields. In an embodiment, the user interface defined by application definition 230 and application data 240 provides access to database 281. In another embodiment, the user interface defined by application definition 230 and application data 240 provides access to application 284.

Processor 275 can be any type of computer processor, analogous to those described for processor 210. Processor 275 accesses/stores data and instructions from/to storage 278. Storage 278 can be any type of non-volatile storage, analogous to that described for diskette drive 122, hard disk drive 123, and tape drive 124.

The configuration depicted in FIG. 1 is but one possible implementation of the components depicted in FIG. 2A. Portable computers, laptop computers, and network computers or Internet appliances are other possible configurations. The hardware depicted in FIG. 2A may vary for specific applications. For example, other peripheral devices such as optical-disk media, audio adapters, or chip programming devices, such as PAL or EPROM programming devices may be used in addition to or in place of the hardware already depicted. Thus, an embodiment of the invention can apply to any hardware configuration that allows developing a user interface, regardless of whether the hardware configuration is a complicated, multi-user computing apparatus, a single-user workstation, or a network appliance that does not have non-volatile storage of its own.

As will be described in detail below, aspects of an embodiment pertain to specific method steps implementable on computers. In another embodiment, the invention can be implemented as a computer program product for use with a computer system. The programs defining the functions of the embodiment can be delivered to a computer via a variety of signal-bearing media, which include, but are not limited to:

(1) information permanently stored on non-writeable storage media (e.g., read only memory devices within a computer such as CD-ROM disks) readable by an unillustrated CD-ROM drive;

(2) alterable information stored on rewriteable storage media (e.g., floppy disks within diskette drive 122, tape drive 124, or hard-disk drive 123); or

(3) information conveyed to a computer by a communications media, such as through a computer or telephone network including wireless communications.

Such signal-bearing media, when carrying computer-readable instructions that direct the functions of the present invention, represent embodiments of the present invention.

FIG. 2B depicts server 188 connected to multiple clients 110-1, 110-2, and 110-3. Server 188 may include specification 290, which server 188 may send to each of clients 110-1, 110-2, and 110-3. Client 110-1 may include host 291 and interpreter 297, client 110-2 may include host 292 and interpreter 298, and client 110-3 may include host 293 and interpreter 299. Hosts 291, 292, and 293 accept specification 290 and translate into a form acceptable to their respective interpreters 297, 298, and 299. For example, in an embodiment, host 291 may be a browser host with interpreter 297 being a browser, host 292 may be a Microsoft.net host with interpreter 298 being a Winform, and host 293 may be a Java/Swing host with interpreter 299 being Swing. In this way, the same specification may be used on multiple platforms.

FIG. 3 depicts a pictorial representation of an example user interface for creating a new screen object, according to an embodiment of the invention. Browser window 300 is shown displayed on display device 114, which browser 225 created by interpreting the data in application data 240. Browser window 300 contains menu 302 and submenus 303 and 304. When the user selects menu-option 305 in menu 302, browser 225 interprets application data 240 to create submenu 303, which contains sub-menu options screen 310, business object model 315, payload model 320, project 325, and controller 330. Options 310, 315, 320, 325, and 330 are all types of objects that browser 225 can create by interpreting application data 240. When the user selects screen 310, browser 225 interprets application data 240 to create submenu 304, which contains sub-menu options dialog 335, fixed-size screen 340, and free-form screen 345, which are all types of screen objects that browser 225 can create by interpreting the data in application data 240. The format and contents of menu 302 and submenus 303 and 304 are examples only, and application data 240 could specify any appropriate menu contents and format.

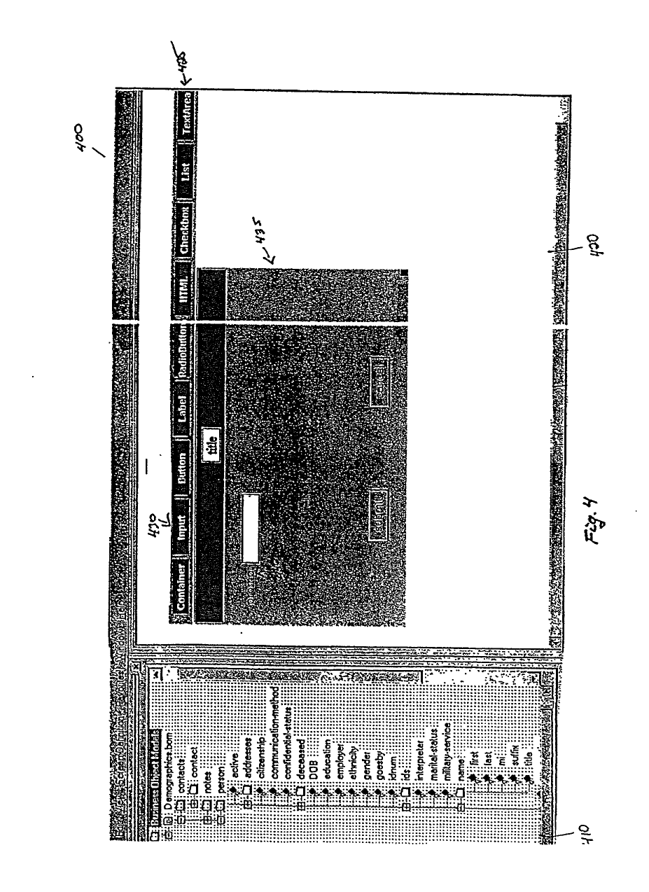

FIG. 4 depicts a pictorial representation of an example user interface for creating a screen object, according to an embodiment of the invention. Browser window 400 is shown displayed on display device 114, which browser 225 created by interpreting the data in application data 240 after the user selected sub-menu option dialog 335, as described above under the description for FIG. 3. Browser window 400 contains first frame 410 and second frame 420, which browser 225 created by interpreting the data in application data 240. First frame 410 contains a tree structure of fields that correspond to data fields in database 281. Second frame 420 contains a user interface for creating a user-interface screen object for accessing or manipulating data in a specified data field in database 281. Second frame 420 contains widgets 425, which are types of interfaces that can be created in a screen object. The widgets shown are container, input, button, label, radio button, HTML, checkbox, list, and text area. In this example, the user selected input 430, which caused browser 225 to interpret application data 240 to display input interface 435, which contains prompt 440.

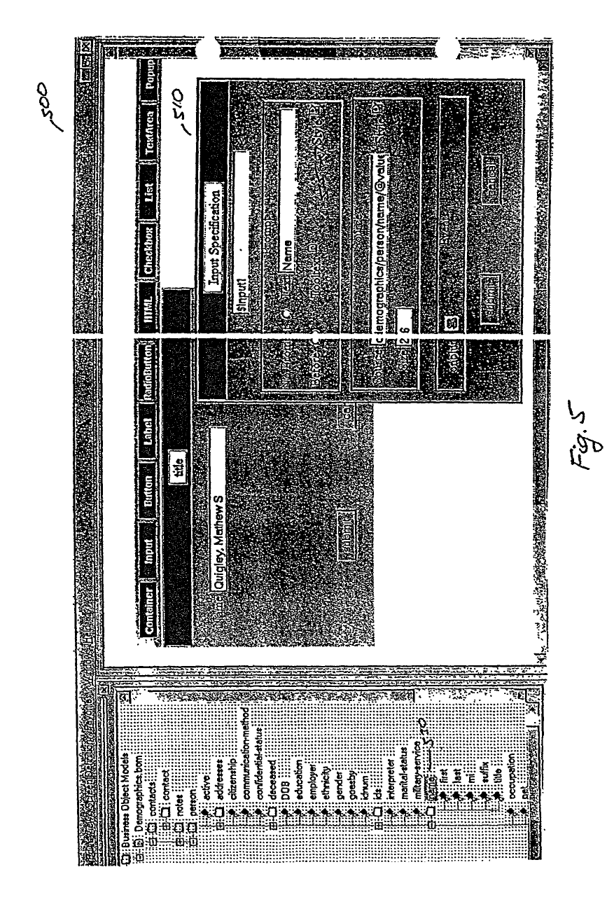

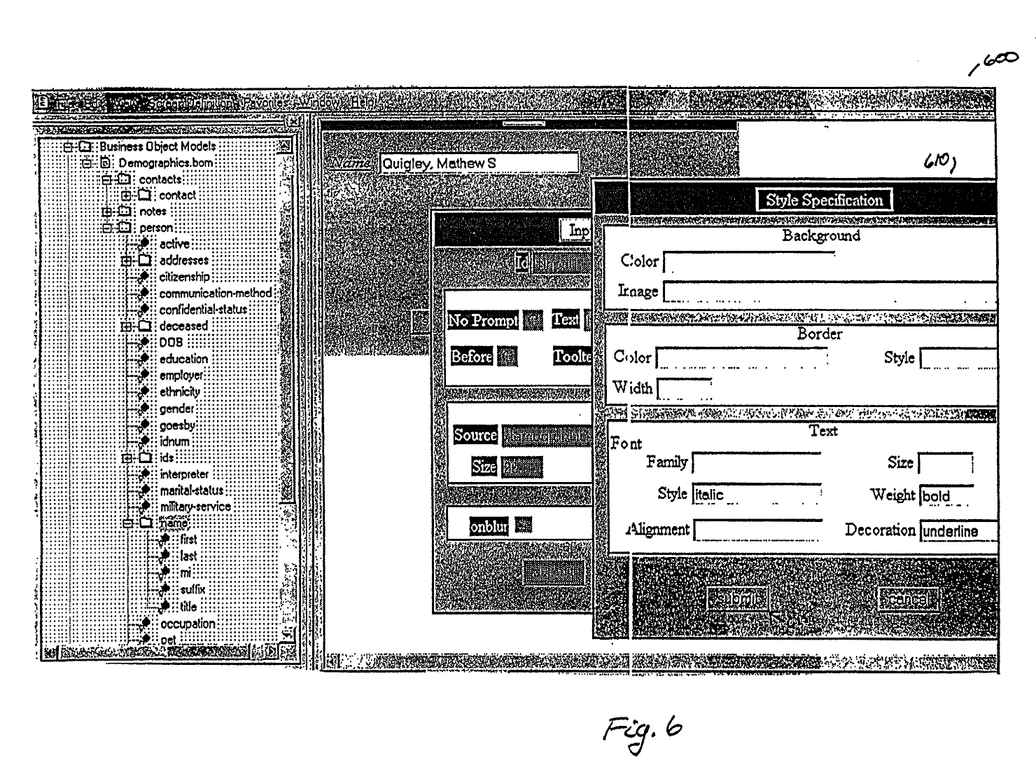

FIG. 5 depicts a pictorial representation of an example user interface for creating an input specification, according to an embodiment of the invention. Browser window 500 is shown displayed on display device 114, which browser 225 created by interpreting the data in application data 240 after the user selected prompt 440. Browser window 500 contains input specification 510, which contains id field 520, source field 525, and style button 535. Id field 520 allows the user to give a name to the input field in the widget, so that code can later to be written to access it. Source field 525 allows the user to specify the address of the field in database 281. In this example, browser 225 interpreted application data 240 to allow the user to drag and drop name 530 into source field 525. In response to entering the address into source field 525, browser 225 interprets application data 240 in order to bind the screen object being created to the name field within database 281. This data binding is further described below under the description for FIG. 11. When the user selects style button 535, browser 225 interprets application data 240 in order to create the browser window shown in FIG. 6.

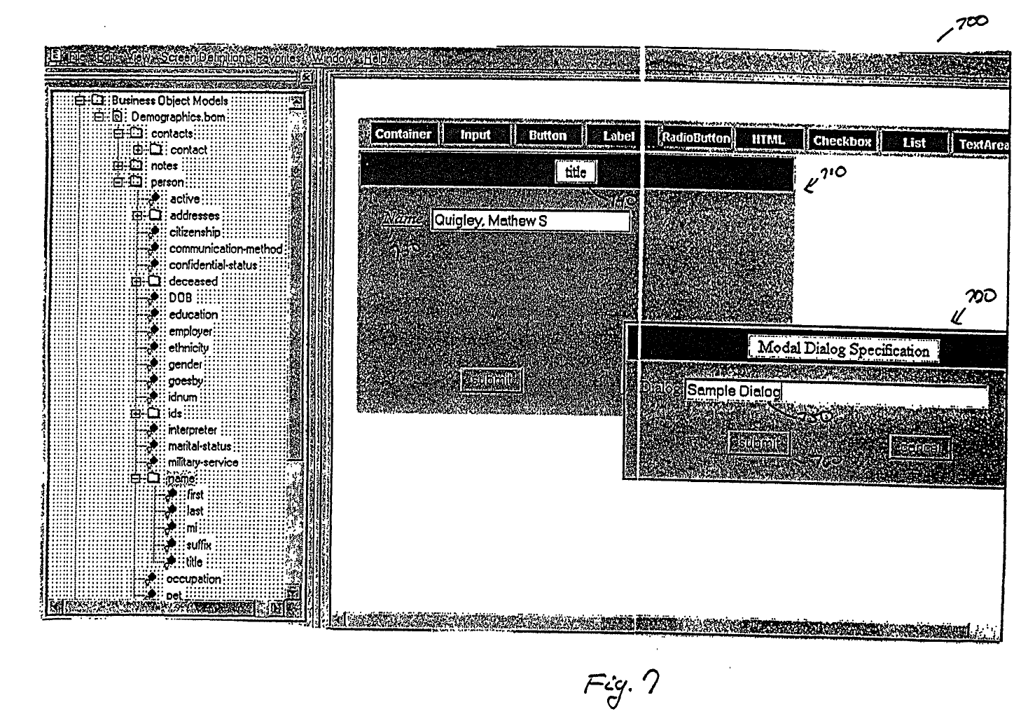

FIG. 6 depicts a pictorial representation of an example user interface for creating a style sub-specification, according to an embodiment of the invention after the user has selected style button 535. Browser window 600 is shown displayed on display device 114. Browser window contains style specification 610, which browser 225 displayed by interpreting application data 240. Style specification 610 allows the user to specify the display style characteristics of the screen object. In this example, the user has specified italic, bold, and underline for the text in the screen object. When the user is done specifying the style, the user clicks submit 615, which causes browser 225 to interpret application data 240 to create the browser window shown in FIG. 7, as further described below.

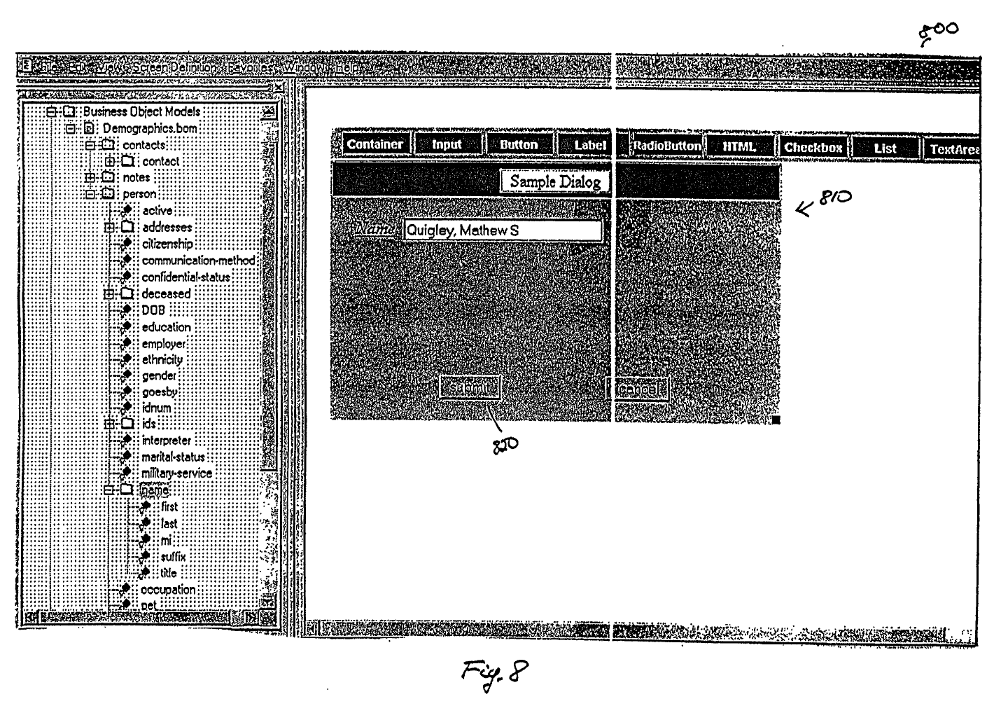

FIG. 7 depicts a pictorial representations of an example user interface for creating a modal screen object specification, according to an embodiment of the invention after the user has specified the style of the screen object. Browser window 700 is shown displayed on display device 114. Browser window 700 contains screen object 710 and screen object specification 720. Screen object 710 contains name 730, which is in bold, italics, and underlined because the user specified those style characteristics as previously shown in FIG. 6. Referring again to FIG. 7, when the user selects title 740 in screen object 710, browser 225 interprets application data 240 to create screen object specification 720, which allows the user to change the contents of title 740. In this example, the user typed sample dialog 750. After the user selects submit button 760, the browser window shown in FIG. 8 is displayed, as further described below.

FIG. 8 depicts a pictorial representation of an example user interface that shows the result of the specification of the screen object's title. Browser window 800 is shown displayed on display device 114. Browser 225 interpreted application data 240 to display screen object 810, which now includes the sample dialog title previously specified by the user in FIG. 7. When the user selects submit button 820, browser 225 interprets application data 240 and various user input shown in FIGS. 3-7 to create documents 250, which is further described below under the description for FIG. 10. In another embodiment, browser 225 creates documents 250 as the various submit buttons are selected in FIGS. 3-7.

FIG. 9 depicts example contents of business objects 242, which is used to run an embodiment of the invention. FIG. 9 shows window 900 containing example code and data 261. In an embodiment, business objects 242 contains XML (Extensible Markup Language) and Javascript, but in other embodiments any suitable protocol can be used.

FIG. 10 depicts example contents of documents 250, which was created by GUI controller 255, according to an embodiment of the invention.

FIG. 11 illustrates a flowchart that describes a method for carrying out a design-time embodiment of the invention. Control begins at block 1100. Control then continues to block 1110 where browser 225 reads application data 240. In an embodiment, application data 240 is downloaded from code and data 283 on server 188. In another embodiment, a server is not used and application data 240 already exists on client 110. Control then continues to block 1120 where browser 225, in response to reading application data 240, displays various user interfaces on display screen 114, as previously shown in FIGS. 3-10. Control then continues to block 1130 where browser 225 retrieves information specified by the user, as previously shown in FIGS. 3-8. Control then continues to block 1140 where browser 225 creates documents 250 based on the user information retrieved and based on application data 240. In an embodiment, browser 225 binds fields in documents 250 to fields in database 281. In another embodiment, a database is not used; instead, documents 250 defines displayed screens. Control then continues to block 1199 where the function returns.

FIG. 12 illustrates a flowchart that describes a method for carrying out a runtime embodiment of the invention. Control begins at block 1200. Control then continues to block 1205 where browser 225 receives a request from a user. In response to the request, browser 225 downloads GUI controller 255 from code and data 283 on server 188 using servlet 282. In another embodiment, GUI controller 255 resides on client 110, so there is no need to download it.

Control then continues to block 1210 where GUI controller 255 begins executing and sends a message to server 188 requesting data. In an embodiment, the request contains such information as an identification of the requested application and the client's current context, which includes the user's ID and security information. In another embodiment, the request can also include application-specific elements.

Control then continues to block 1215 where, servlet 282 transfers application definition 230 and application data 240 from code and data 283 to client 110. Control then continues to block 1220 where GUI controller 255 unpacks the constituent elements of application definition 230 and application data 240 and reads and processes them to create documents 250, which describes a screen of the application's user interface. In an embodiment, GUI controller 255 uses HTML (Hypertext Markup Language) and DOM (Document Object Model) to create documents 250.

Control then continues to block 1225 where browser 225 reads and interprets documents 250 to display the application's interface screen to the user on display 114. Control then continues to block 1230 where browser 225 sends events to GUI controller 255 that contain information about user interface actions and user-supplied data, examples of which are shown in FIGS. 3-8. Control then continues to block 1235 where GUI controller 255 updates documents 250 based on the events received in block 1230.

Control then continues to block 1240 where GUI controller 255 determines whether another interface screen needs to be displayed based on the application defined in application definition 230, application data 240, and the user event received in block 1230. If the determination at block 1240 is true, then control continues to block 1245 where GUI controller 255 determines whether more data is needed. If the determination at block 1245 is true, then control returns to block 1210 where GUI controller 255 retrieves more data, as previously described above. If the determination at block 1245 is false, then control returns to block 1220 where GUI controller 255 prepares the next interface screen for the application, as previously described above.

If the determination at block 1240 is false, then control continues to block 1250 where GUI controller 255 creates a summary of changes made to business objects 242. Control then continues to block 1255 where GUI controller 255 packages the summary of changes and the current client context into a change order and sends the change order to server 188. Control then continues to block 1260 where servlet 282 receives the change order makes the changes persistent. In an embodiment, servlet 282 makes the changes persistent in database 281. Control then continues to block 1265 where servlet 282 initiates application 284 to carry out the mission of the transaction embodied in the change order. Completion of the transaction, either success or failure, is returned to client 110 in a response message. Control then continues to block 1299 where the function stops.

Although the design-time logic of FIG. 11 and the run-time logic of FIG. 12 are illustrated in two different figures, in an embodiment the design-time and runtime environments co-exist simultaneously, so that the user can see the results of the interface specification as it is designed.

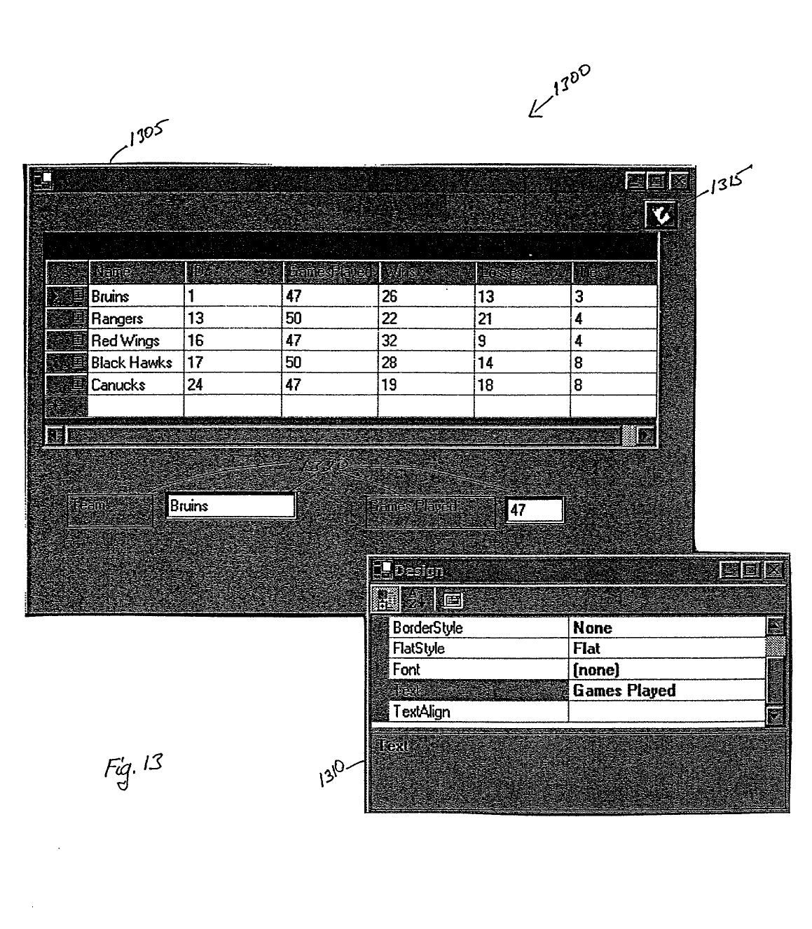

FIG. 13 illustrates a pictorial representation of an example user interface 1300 for modifying a specification simultaneously with running an application, according to an embodiment of the invention. User interface 1300 may include application window 1305 and edit window 1310. In response to the user selecting edit button 1315, items 1320 within application window 1305 are highlighted, indicating to the user that the format for items 1320 maybe modified. Although the items 1320 are shown highlighted via a rectangle drawn around them, in another embodiment any appropriate means of highlighting may be used. In response to the user selecting one of items 1320, edit window 1310 is displayed, which allows the user to request that the specification be modified concurrently with the running of the application.

In this way, an easy-to-use tool is provided for the creation of applications and the customization of the applications while the applications are running. The most current version of the application may be distributed in a secure form and single applications may run on multiple technologies. This distribution resolves the problem of keeping programs updated on multiple client machines and avoids the security issues that arise when executable code is transmitted to clients. Since the actual implementation of the specification takes place via a controlled host, it can be assured that no malicious actions are performed. In contrast, systems based on receiving and executing binary code are vulnerable to having legitimate code intercepted and malicious codes substituted in its place. Further, applications may be made up of many customizable components called specifications, where customizable specifications may be supplied at many levels, such as organization, division, department, location, and ultimately the end user. The self-customization behavior is built into the specifications.

What is claimed is:

1. A computer-implemented method, comprising:
creating a specification for an application, wherein the specification is independent of a hardware platform on which the application is to be run;
instantiating the application from the specification;
running the application; and
modifying the specification concurrently with the running the application.

2. The method of claim 1, wherein creating the specification further comprises:
creating a description of a model in the specification.

3. The method of claim 1, wherein creating the specification further comprises:
creating a description of a view in the specification.

4. The method of claim 1, wherein creating the specification further comprises:
creating a description of a controller in the specification.

5. The method of claim 1, wherein creating the specification further comprises:
creating the specification to have a model-view-controller architecture.

6. The method of claim 1, wherein creating the specification further comprises:
creating a description of an appearance of a screen and an identification of a location of data to be displayed on the screen.

7. The method of claim 1, wherein the specification is suitable for interpretation by a browser.

8. The method of claim 1, wherein creating the specification further comprises creating customizable, substitutable parts.

9. A computer-implemented method, comprising:
constructing screen specifications and controllers using input from a user; and
providing feedback to the user on the appearance and behavior of the screen specifications and controllers concurrently with the constructing of the screen specifications.

10. The method of claim 9, further comprising:
creating documents from an application definition and an application data.

11. The method of claim 10, further comprising:
updating the documents based on user input.

12. The method of claim 9, further comprising:
sending the documents to a server.

13. The method of claim 12, further comprising:
updating a database at the server based on the documents.

14. The method of claim 10, further comprising:
binding fields in the documents to fields in a database.

15. A signal-bearing medium encoded with instructions that when executed comprise:
creating a specification for an application, wherein the specification is independent of a hardware platform on which the application is to be run;
instantiating the application from the specification;
running the application; and
modifying the specification concurrently with the running the application.

16. The signal-bearing medium of claim 15, wherein creating the specification further comprises:
creating a description of a model in the specification

17. The signal-bearing medium of claim 15, wherein creating the specification further comprises:
creating a description of a view in the specification.

18. The signal-bearing medium of claim 15, wherein creating the specification further comprises:
creating a description of a controller in the specification.

19. The signal-bearing medium of claim 15, wherein creating the specification further comprises:
creating the specification to have a model-view-controller architecture.

20. The signal-bearing medium of claim 15, wherein creating the specification further comprises:
creating a description of an appearance of a screen and an identification of a location of data to be displayed on the screen.

21. The signal-bearing medium of claim 15, wherein the specification is suitable for interpretation by a browser.

22. A computer comprising:
a processor; and
storage encoded with instructions that when executed on the processor comprise:
creating a specification for an application, wherein the specification is independent of a hardware platform on which the application is to be run,
instantiating the application from the specification, and
running the application concurrently,
modifying the specification concurrently with the running the application.

23. The computer of claim 22, wherein creating the specification further comprises:
creating a description of a model in the specification

24. The computer of claim 22, wherein creating the specification further comprises:
creating a description of a view in the specification.

25. The computer of claim 22, wherein creating the specification further comprises:
creating a description of a controller in the specification.

26. The computer of claim 22, wherein creating the specification further comprises:
creating the specification to have a model-view-controller architecture.

27. The computer of claim 22, wherein creating the specification further comprises:
creating a description of an appearance of a screen and an identification of a location of data to be displayed on the screen.

28. The computer of claim 22, wherein the specification is suitable for interpretation by a browser.
